(19) United States
(12) Patent Application Publication
(10) Pub. No.: US 2005/0049015 A1
(43) Pub. Date: Mar. 3, 2005

(54) Portable device for both media playing and wireless communication

(76) Inventor: Tai-Chang Wang, Taipei (TW)

Correspondence Address: SUPREME PATENT SERVICES, POST OFFICE BOX 2339, SARATOGA, CA, 95070, US

(21) Appl. No.: 10/703,837

(22) Filed: Nov. 6, 2003

(30) Foreign Application Priority Data
Sep. 3, 2003 (TW) 092215951

(51) Int. Cl. H04B 1/38; H04M 1/00

(52) U.S. Cl. 455/575.1; 455/557

(57) ABSTRACT

A portable device for both media playing and wireless communication is disclosed, including a housing case, and a circuit board housed inside the housing case. A wireless communication unit is electrically connected to a switch and the wireless communication unit includes an integrated IC chip for wireless communication. The switch is switchable to wireless communication unit for communication upon receiving commands from users or receiving incoming calls for voice signal or data communication. The switch is used to control input unit for transmitting voice signal to wireless communication unit.

### FIELD OF THE INVENTION

The present invention relates to a portable device for both media playing and wireless communication and, more particularly, to a portable device with a switch controlling the capability of media playing and wireless communication.

### BACKGROUND OF THE INVENTION

The recent development of digital music or media players has evolved into many surprising models in the market. Taking the mini MP3 players as an example, the models available in the market can be categorized in four different types:
(1) hard disk type, with iPod from Apple Inc., and Gigabeat Meg50JS from Toshiba as representative models, (2) compact disk type, with Sharp DR7 portable recorder mini disk, md and Sharp DS5 portable recorder mini disk, md from Sharp, (3) memory card type, with Panasonic SV-SD80 from Japan and MPIO FL100 from South Korea as representative models, and (4) multi-function type, with Audio Steno BP300 and Moonlight Box, both from Taiwan.

On the other hand, the cellular phones have undergone several generations of evolution. Most recent cellular phones provide multiple functions, and ubiquitous accessibility to improve the convenience.

However, as portable devices, such as walkman, cellular phones, and PDAs, are mostly used during activity or motions, convenience is the most important consideration in the design of such devices. Therefore, the present invention uses a switch and adds a wireless communication unit to a portable media player. Through the wireless communication unit, users can transmit or receives voice signals or data information signals. So that users of the present invention can enjoy ubiquitous accessibility while listening to music.

### SUMMARY OF THE INVENTION

An object of the present invention is to add a wireless communication unit in a portable media player, and use a switch to control the reception of the voice and data signals.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 shows a perspective view of a portable device in accordance with an embodiment of the present invention in cap-off mode.

FIG. 2 shows a perspective view of the portable device in cap-on mode.

FIG. 3 shows a schematic view of the portable device used during walking activity.

FIG. 4 shows a schematic view of the portable device used during sports activity.

FIG. 5 shows a block diagram of the internal circuit of the prior arts.

FIG. 6 shows a block diagram of the internal circuit of the present invention.

### DETAILED DESCRIPTION OF THE INVENTION

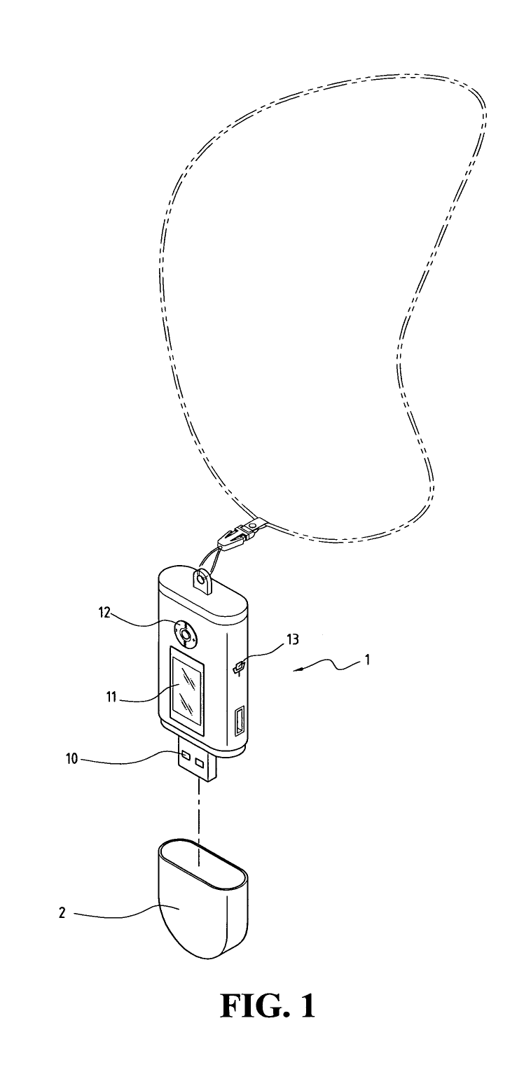

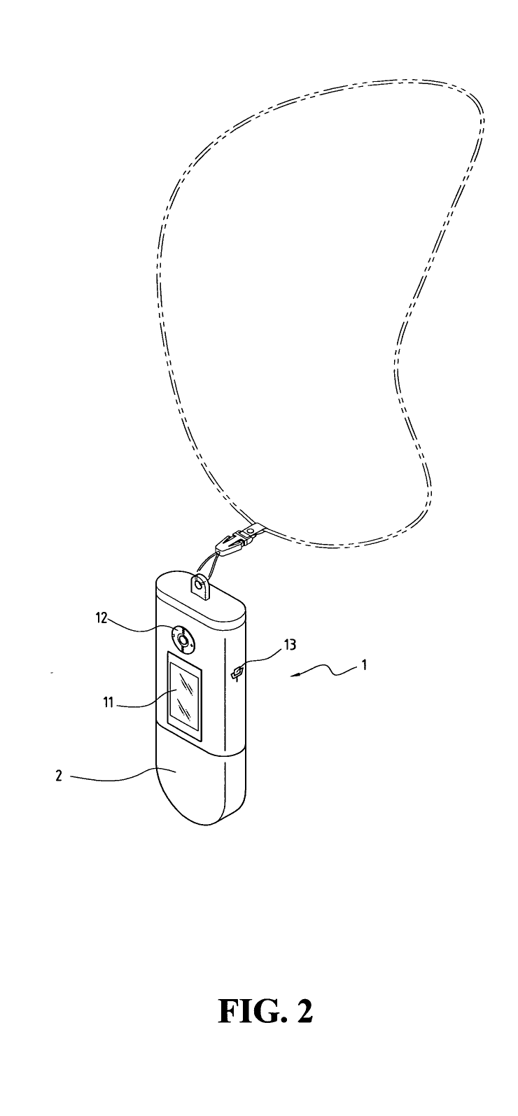

With reference to the drawings and in particular to FIGS. 1 and 2, a portable device constructed in accordance with the present invention comprises a housing case 1, having a USB (Universal Serial Bus) connector 10 at the lower part for drawing power and transmitting data, such as images, video, text, or music. Housing case 1 has an LCD (Liquid Crystal Display) 11 at the front for displaying the operation status to the users. The housing case 1 has a plurality of buttons 12 at the front for users to input commands to change the operation mode of music playing. The housing case 1 has a switch 13 on the side for switching between media access/play mode to access data on the media, and wireless communication input mode to receive input from the wireless communication unit (not shown). When an incoming voice signal from the integrated IC (Integrated Circuit) chips of the present invention is received, the switch 13 changes from the media access/play mode to wireless communication mode. During the wireless communication mode, the voice is transmitted to the speakers or the earphones of the wireless communication unit (not shown).

A cap 2 is provided at the lower part of the housing case 1. The cap 2 is fit to or engages the lower part of the housing case 1 in order to cover and protect the USB connector 10 from damage.

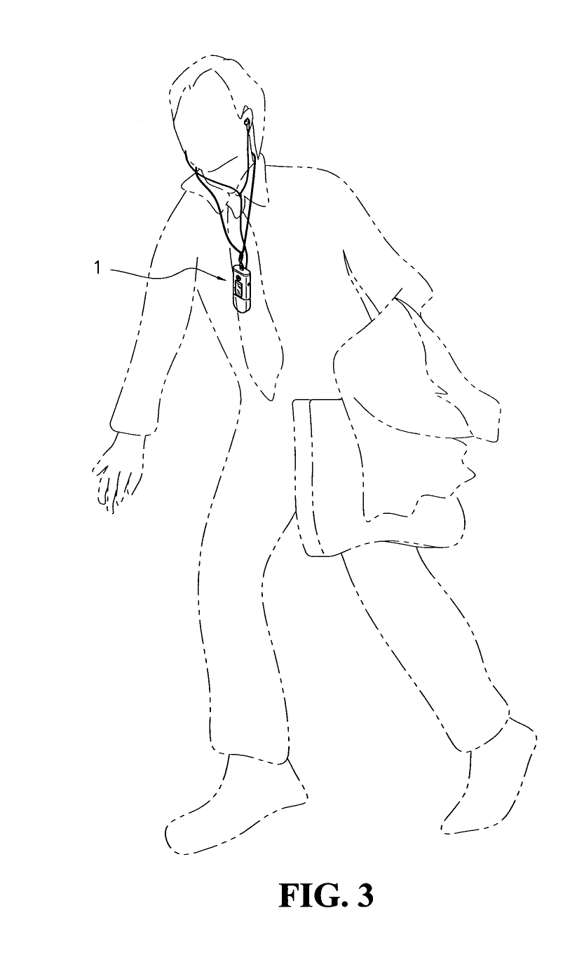

FIG. 3 shows that the portable device of the present invention is used by an office worker during walking. As the present invention is thin in size and light in weight, it can even be worn by office workers on roller skates. Furthermore, the ability of fast switching to wireless communication mode is an important feature so that important messages will not be missed.

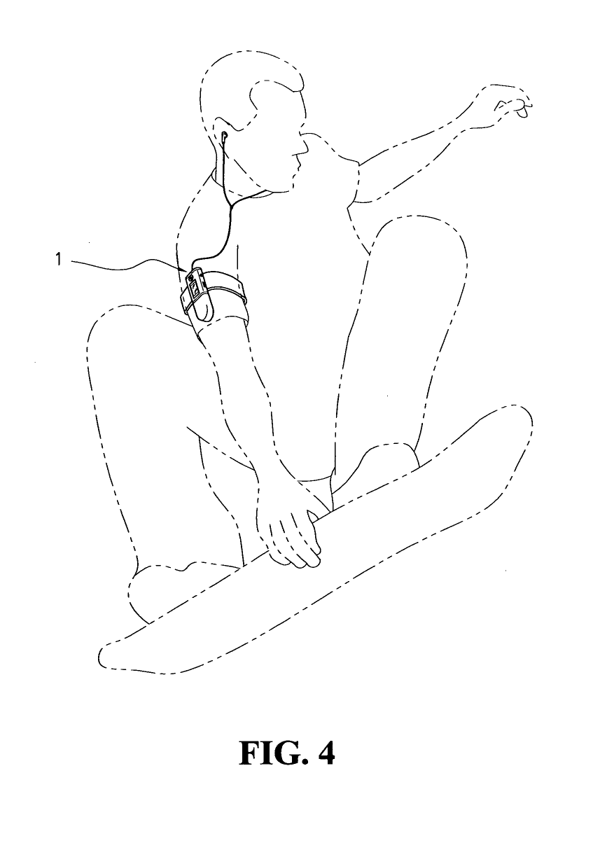

FIG. 4 shows that the portable device of the present invention is used by a user during sport activity, such as snowboarding or surfing. The user can enjoy music during sports activity. The ability of fast switching to wireless communication mode is an important feature so that important messages will not be missed.

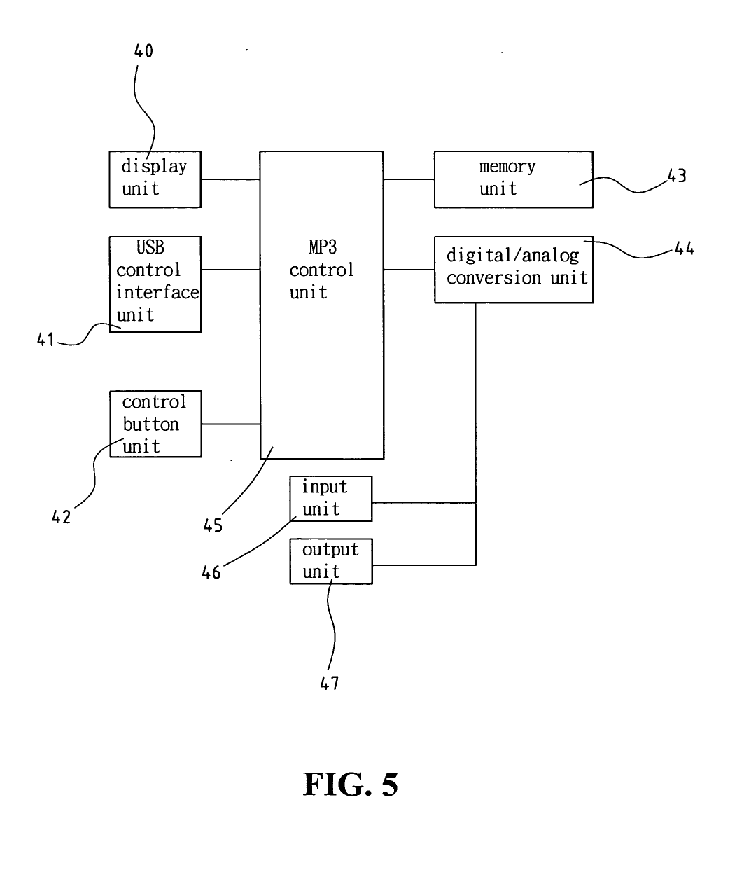

FIG. 5 shows a block diagram of the internal circuit of the conventional device. In the conventional device, a housing case 1 houses a circuit board (not shown), comprising:
a display unit 40, a liquid crystal display for displaying operation status to users,
a USB control interface unit 41, electrically connected to USB connector 10 at one end, for drawing power and transmitting data, such as images, video, and text. The present embodiment uses the south bridge chip set SiS964SiMuTIOL®Media I/O from SiS Inc.,
a control button unit 42, further comprising a plurality of buttons for users to input commands to change music playing mode, for example, Play, Stop, Fast Forward (FF), Fast Reverse (FR), Repeat, and Random,
a memory unit 43, being a compact disk, hard disk, memory chip, or memory card. The present embodiment uses the DDR SDRAM with module ID EBD52UC8AKFA-5C and component ID DD2508AKTA-5C from Elpida, with type 32M×16, and clock rate 400 MHz,
a digital/analog conversion unit 44, where the circuit for converting analog signal to digital signal is a12-bit A/D convertor, which can read analog signals from 8 channels, and the circuit for converting digital signal to analog signal is a 12-bit D/A convertor, which can read digital signals from two channels,
an MP3 control unit 45, a 32-bit microprocessor, electrically connecting to display unit 40, USB control interface unit 41, control button unit 42, memory unit 43 and digital/analog conversion unit 44 for coordinating operations between units. The present enbodiment uses the 32-bit microprocessor SiS 550/2 from SiS,
an input unit 46, a CD/VCD head, electrically connecting to digital/analog conversion unit 44 for reading data on CD/VCD, such as images, video, text, and music, and
an output unit 47, a speaker or an earphone, electrically connecting to digital/analog conversion unit 44 for outputting music or warning voice signals to users.

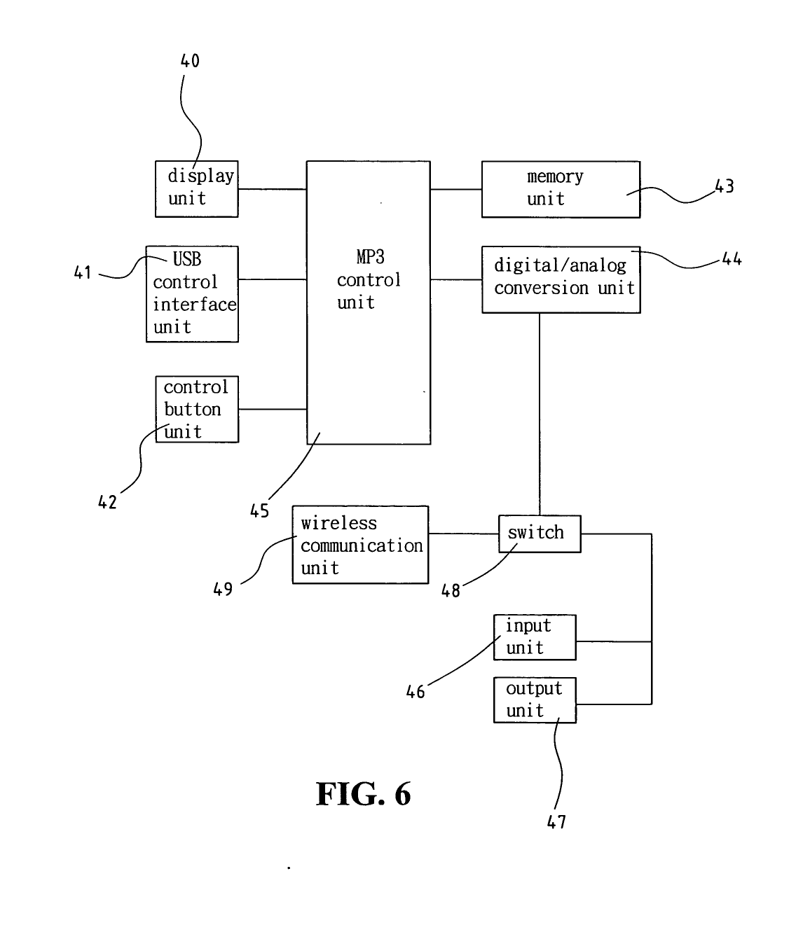

FIG. 6 shows a block diagram of the internal circuit of an embodiment of the present invention. Compared to FIG. 5, the present invention comprises the additional components of a switch 48, and a wireless communication unit 49. Switch 48 can switch to input unit 46 to read data on the CD/VCD, such as images, video, text and music, transmit decoded music data to the speaker or earphone of output unit 47. Alternatively, switch 48 can switch to wireless communication unit 49 for inputting incoming voice and transmitting to the speaker or earphone of output unit 47.

While the invention has been described in connection with what is presently considered to the most practical and preferred embodiment, it is to be understood that the invention is not to be limited to the disclosed embodiment, but, on the contrary, it should be clear to those skilled in the art that the description of the embodiment is intended to cover various modifications and equivalent arrangement included within the spirit and scope of the appended claims.

1. A portable device for both media playing and wireless communication, comprising:
a housing case, and
a circuit board, housed inside the housing case and comprising a USB control interface unit electrically connecting to a USB connector at one end for drawing power, or transmitting images, video, and text,
wherein a wireless communication unit is electrically connected to a switch, the wireless communication unit comprises an integrated IC chip for wireless communication, the switch is switchable to wireless communication unit for communication upon receiving commands from users or receiving incoming calls, otherwise, switch to music playing mode.
